(19) United States
(12) Patent Application Publication
(10) Pub. No.: US 2008/0007152 A1
(43) Pub. Date: Jan. 10, 2008

(54) Electron emitting element

(75) Inventors: Masahide Yamauchi, Kyoto-shi (JP); Makoto Yamamoto, Takarazuka-shi (JP)

Correspondence Address: Hamre, Schumann, Mueller & Larson, P.C., P.O. Box 2902, Minneapolis, MN, 55402, US

(73) Assignee: MT Picture Display Co., Ltd., Takatsuki-shi (JP)

(21) Appl. No.: 11/825,003

(22) Filed: Jul. 3, 2007

(30) Foreign Application Priority Data
Jul. 7, 2006 (JP) 2006-188237

(51) Int. Cl. H01J 63/04; H01J 1/00

(52) U.S. Cl. 313/495; 313/311

(57) ABSTRACT

An electron emitting element includes a vacuum container 3, electron sources that emit an electron beam, and a power supply structure 4 that supplies a voltage to the electron sources. The electron sources are formed on a silicon substrate 21. The power supply structure 4 is disposed outside the vacuum container 3.

### BACKGROUND OF THE INVENTION

1. Field of the Invention

The present invention relates to an electron emitting element used for image display or image pickup by an electron beam emitted in a vacuum container.

2. Description of Related Art

An electron emitting element can be used as an image displaying element or image pickup element. An example in which an electron emitting element is used as an image displaying element or image pickup element is disclosed in JP H8-106869A. FIG. 5 shows a schematic perspective view of an example of a conventional electron emitting element serving as an image displaying element. A cold cathode array portion 32 and an anode portion 31 are disposed in a vacuum container 30.

When an electron emitting element is used as an image displaying element or image pickup element, in order to improve its image quality, that is, its resolution, the size of the pixels needs to be reduced. When an electron emitting element is used as an image pickup element, in order to reduce the size of the image pickup apparatus such as a camera body, the size of image pickup element needs to be reduced.

In the above-mentioned cases, due to the reduction of pixel size, it is necessary to reduce further the size of the power supply structure serving as a voltage supplier to the cold cathode array serving as a pixel structure, so as to achieve a high density power supply structure. A conventional technique for realizing a high density power supply method is proposed in, for example, JP 2003-338518A (not shown in the drawings). According to this technique, a high density power supply structure can be realized without causing short circuiting between adjacent wires.

However, the conventional technique has a problem that, when a power supply structure made of resin is included in the vacuum container, gas is emitted by the polymer in the vacuum container, causing troubles in the emission of electron beam due to a degradation in the degree of vacuum in the vacuum container or a contamination of the electron sources.

Meanwhile, as a metal wiring method that releases less organic outgas in the vacuum environment, there is a wire bonding method using a gold wire, aluminum wire or the like. In this method, in order to reduce the distance between adjacent wires, it is necessary to reduce the diameter of wires and to reduce the size variation of the bonded portions to a small and stable size. In this case, the wires having a small diameter break easily to, and, in order to realize a bonding using small-diameter wires, micro-fabricated capillaries are necessary. For this reason, a high density power supply structure using a wire bonding method has a problem that its handling is extremely difficult and of little practical use. In other words, with a conventional power supply structure, it is difficult to achieve both sufficient performance in the vacuum environment and high density.

### SUMMARY OF THE INVENTION

The present invention is intended to solve the conventional problems described above. It is an object of the present invention to provide an electron emitting element that can realize a high density wiring structure without causing a degradation in the vacuum environment and a contamination of the electron sources.

In order to achieve the above-described object, the electron emitting element of the present invention comprises a vacuum container, electron sources that emit an electron beam, and a power supply structure that supplies a voltage to the electron sources, wherein the electron sources are formed on a silicon substrate, and the power supply structure is disposed outside the vacuum container.

### BRIEF DESCRIPTION OF THE DRAWINGS

FIGS. 1A and 1B are schematic views of an electron emitting element according to Embodiment 1 of the present invention.

FIGS. 2A, 2B and 2C are perspective views of an electron source assembly 2 according to Embodiment 1 of the present invention.

FIG. 3 is a cross sectional view of a power supply structure according to Embodiment 1 of the present invention.

FIGS. 4A and 4B are schematic views of an electron emitting element according to Embodiment 2 of the present invention.

FIG. 5 is a schematic perspective view of an example in which a conventional electron emitting element serves as an image displaying element.

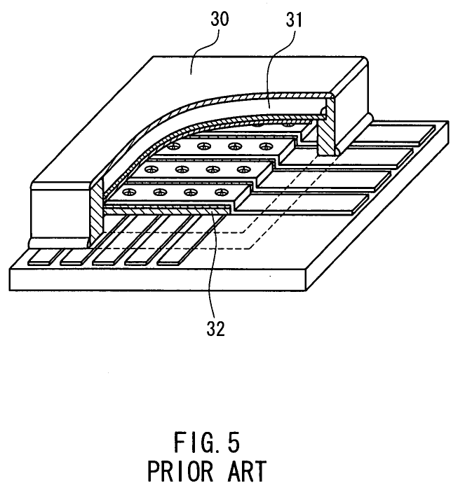

### DETAILED DESCRIPTION OF THE INVENTION

According to the present invention, it is possible to provide an electron emitting element that can realize a high density wiring structure without causing a degradation in the vacuum environment and a contamination of the electron sources.

According to the present invention, it is possible to use a power supply structure in which the spacing between adjacent wires is reduced while preventing problems in the emission of electron beam due to a degradation in the degree of vacuum and a contamination of the electron sources, which are caused by gas released in the vacuum container. Accordingly, a larger number of electron sources can be disposed at a high density in the array, whereby it is possible to provide an image pickup element or image displaying element having high resolution characteristics.

In the electron emitting element, preferably, the vacuum container and at least part of the silicon substrate are seal-bonded with a sealant, and the sealant is low melting point fusing glass having a thermal expansion coefficient approximately equal to that of the silicon substrate. According to this configuration, it is possible to prevent the silicon substrate from breaking due to heat distortion in the thermal process for sealing.

Preferably, the silicon substrate has thereon a region in which a wiring pattern that supplies a voltage to the electron source from the power supply structure is formed, and, in the region, a spacing between adjacent wires of the wiring pattern is greater at the power supply structure side than at the electron source side. According to this configuration, a wire bonding method, which is versatile, can be employed as a wiring for the power supply structure.

Hereinafter, embodiments of the present invention will be described with reference to the accompanying drawings.

### Embodiment 1

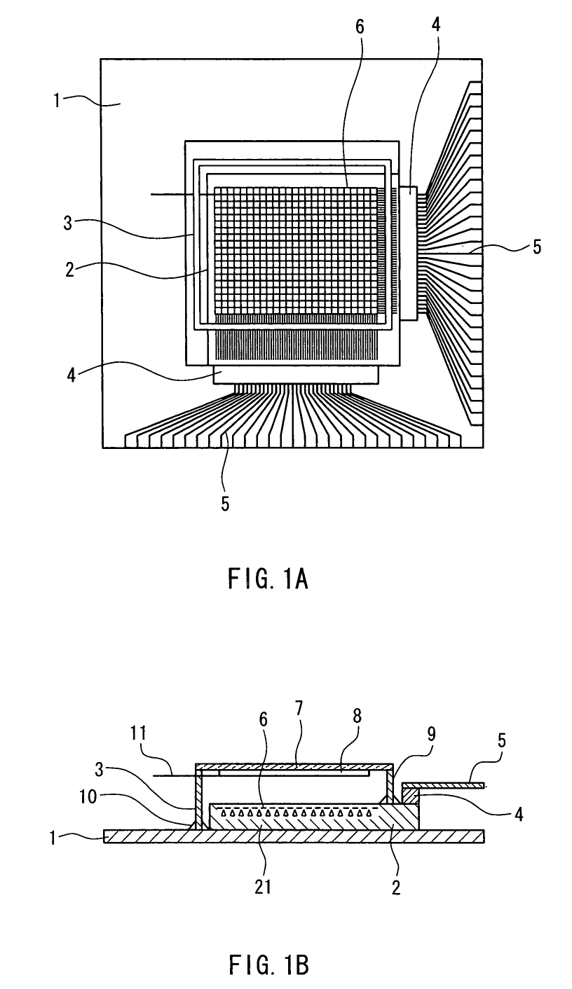

FIGS. 1A and 1B are schematic views of an electron emitting element according to Embodiment 1 of the present invention. The configuration shown in FIGS. 1A to 1B shows an example in which the electron emitting element serves as an image pickup element. FIG. 1A shows a plan view, and FIG. 1B shows a cross sectional view. An electron source assembly 2 and a vacuum container 3 are disposed on a substrate 1. Part of the electron source assembly 2 is disposed in the vacuum container 3. A power supply structure 4 is connected to an external terminal structure 5, so that the electron source assembly 2 and the outside of the image pickup element can be connected electrically.

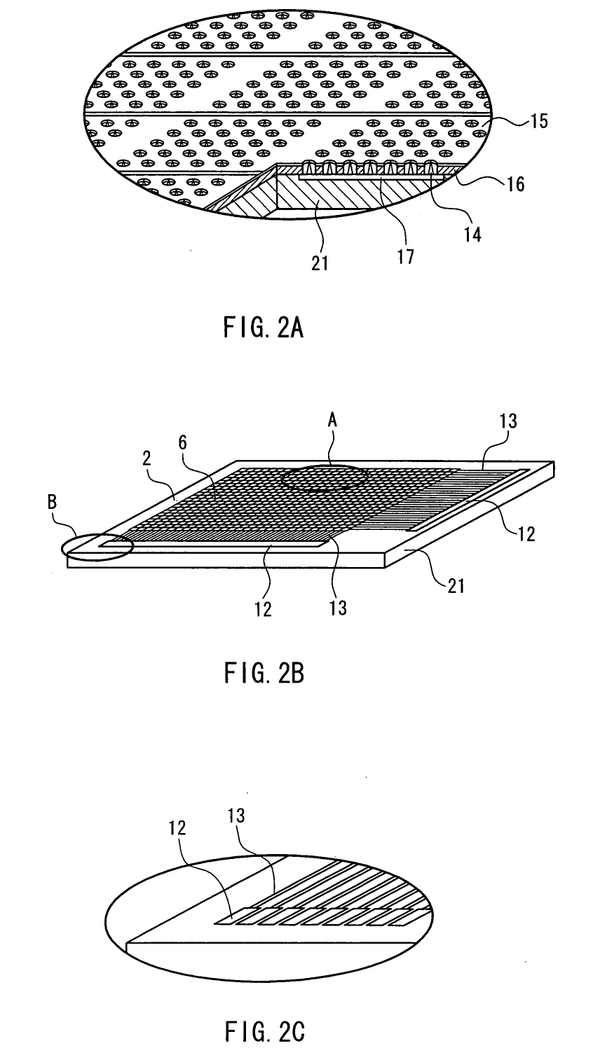

The electron source assembly 2 includes a field emission cold cathode array 6, serving as an electron emission source, formed on a silicon substrate (silicon wafer) 21 in a matrix structure. The cold cathode array 6 includes cathode electrode lines 17, an insulating film 16 and gate electrodes 15 (FIG. 2A). The cold cathode array 6 can be formed by a commonly known production method. For example, a production method disclosed in JP H8-190856A can be employed.

As shown in FIG. 1B, a surface of the vacuum container 3 that faces the cold cathode array 6 serves as a light transmissive window portion 7. On the inner surface of the window portion 7, an image pickup element anode portion 8 is formed. The image pickup element anode portion 8 includes a light transmissive anode electrode and a photoconductive film formed by sputtering or a vapor deposition method.

The side wall portions of the vacuum container 3 are formed by spacers 9, so that the distance between the cold cathode array 6 and the image pickup element anode portion 8 is maintained at a predetermined distance. Further, the vacuum container 3 and the silicon substrate 21, as well as the vacuum container 3 and the substrate 1, are sealed with a sealer 10, whereby the vacuum container 3 may be maintained under a vacuum of 10⁻⁷ Torr.

Also, with a rod-shaped conductor 11 that penetrates the side portion of the vacuum container 3 while retaining vacuum air-tightness, a potential can be supplied to the image pickup element anode portion 8 from the outside.

A material such as soda glass, Pyrex® glass, quartz glass or ceramic that is an insulating material and is capable of retaining vacuum air-tightness can be used as the material of the substrate 1 and the vacuum container 3. Here, soda glass, which is highly versatile, is used so that light transmittance is ensured in the window portion 7 of the vacuum container 3.

In order to form the image pickup element anode portion 8, first, a transmissive anode electrode film having a thickness of about 10 nm is formed on the inner surface of the window portion 7 of the vacuum container 3 by a sputtering method using In₂O₃ containing Sn. Subsequently, a 15 nm thick CeO₂ layer as a positive hole injection blocking layer and a 5 μm thick amorphous Se layer as a photoconductive film are formed by a vacuum deposition method. Thereafter, a 100 nm thick porous film of Sb₂S₃ is formed as an electron beam landing layer by a vapor deposition method in a low Ar gas atmosphere.

The image pickup element according to this embodiment is an image pickup element having a sensitivity mainly to visible light. In contrast, by forming the window portion 7 of the vacuum container 3, on which the image pickup element anode portion 8 is formed, by replacing the material with, for example, a material through which X rays pass easily, such as Be, BN, Al, SiO₂, Al₂O₃, or an organic polymer material, an X ray image pickup element can be formed.

As the sealer 10 that vacuum-seals the vacuum container 3 and the substrate 1, and part of the silicon substrate 21, PbO—BaO₃ based low melting point sealing glass is used that is obtained by blending a filler for adjusting thermal expansion such as a zirconium phosphate based, tungsten phosphate based, or calcium zirconium phosphate based filler.

Thereby, the thermal expansion coefficient of the sealer 10 (low melting point sealing glass) is adjusted to be approximately equal to the thermal expansion coefficient of the silicon substrate 21 of the cold cathode configuration, specifically, α=3×10⁻⁶/° C. This prevents the silicon substrate 21 from breaking due to heat distortion when heated at about 450° C. in the thermal process for sealing.

FIGS. 2A, 2B and 2C are perspective views of the electron source assembly 2 according to Embodiment 1. FIG. 2A is an enlarged view of the part A of FIG. 2B. FIG. 2B is a perspective view showing the whole of the electron source assembly 2. FIG. 2C is an enlarged view of the part B of FIG. 2B. The electron source assembly 2 includes the cold cathode array 6, power supply pads 12 and wiring patterns 13 formed on the silicon substrate 21. The wiring patterns 13 connect the cold cathode array 6 and the power supply pads 12 with wires.

The cold cathode array 6 is divided into a matrix form, and each area of the matrix serves as one pixel of the image pickup element.

In the cold cathode area that serves as one pixel, several tens of electron sources 14 are arranged. The electron sources 14 are formed on the silicon substrate 21. The electron sources 14 are cone shaped having a polygonal pyramid shape, such as a circular pyramid or quadrangular pyramid.

The electron sources 14 correspond one to one to the pores of the gate electrodes 15. Each electron source 14 is separated electrically from the gate electrode 15 by a silicon oxide film serving as an insulator 16, and is fixed. The periphery of the tip of each electron source 14 corresponds to the opening of each gate electrode 15. The gate electrodes 15 are disposed on the silicon wafer 21 with the insulator 16 interposed therebetween.

In each pixel area, the plurality of electron sources 14 are electrically connected. Further, when the pixels are viewed in the vertical (column) direction, the electron sources 14 of each pixel also are connected electrically to those of adjacent pixels at the upper and lower portions by a line of cathode electrode 17 that extends in the vertical direction. Because the gate electrodes 15 are arranged in the horizontal direction, when the gate electrodes 15 are viewed in the horizontal (row) direction, the gate electrodes 15 of each pixel are connected electrically to those of adjacent pixels located at the right and left sides. In other words, the lines of cathode electrodes 17 extending in the vertical direction and the lines of gate electrodes 15 extending in the horizontal direction are arranged in a matrix form. Each line of cathode electrode 17 and each line of gate electrode 15 are connected to the power supply structure 4 by the wiring patterns 13 formed in the silicon wafer 21.

As a working example of the electron source assembly 2 of this embodiment, the aspect ratio of the cold cathode array 6 serving as an image pickup area is set to 4:3, and the diagonal length is set to 16.9 mm. In this case, the number of pixels in the cold cathode area is set to about 310,000 pixels with 480 pixels in the vertical direction and 640 pixels in the horizontal direction. The cold cathode areas are configured such that each cold cathode area has a size of about 21.2 μm square, and includes about 100 cathode electrodes 14 therein. In this case, the whole of the electron source assembly 2 has an outer dimension of about 15 mm square and a thickness of 0.7 mm.

In this working example, a negative potential (−25 V in this case) is applied to each of the vertical lines, that is, the lines of cathode electrodes 17, and a positive potential (+35 V in this case) is applied to each of the horizontal lines, that is, the lines of gate electrodes 15.

In this case, only the cold cathode areas located at the intersections of the lines of cathode electrodes 17 to which a potential is being applied and the lines of gate electrodes 15 to which a potential is being applied emit an electron beam. The lines of cathode electrodes 17 and the lines of gate electrodes 15 to which voltages are applied are scanned by so-called dot sequential scanning in which scanning is performed sequentially from one line to an adjacent line in temporal order, and thereby electron beams are emitted.

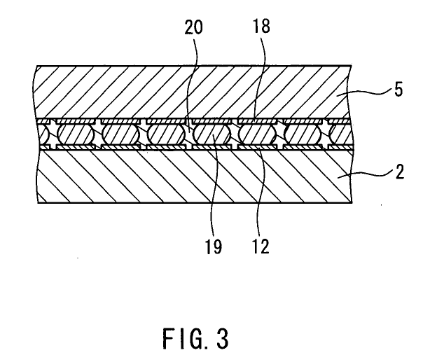

FIG. 3 shows a power supply structure according to this embodiment. Hereinafter, a description will be given of the power supply structure 4 for cathode electrode 17, but the power supply structure 4 for gate electrode 15 also has the same configuration. As shown in FIGS. 2B and 2C, bump pads 12 are formed at the edge portions of the electron source assembly 2. The bump pads 12 correspond to the lines of cathode electrodes 17, respectively. As shown in FIG. 3, at the external terminal structure 5 side, bump pads 18 are formed. The bump pads 12 at the electron source assembly 2 side correspond one to one to the bump pads 18 at the external terminal structure 5 side with a conductive bump 19 therebetween. At the side wall sides of the conductive bumps 19, a side wall insulating film 20 is formed.

The side wall insulating film 20 is formed of a polyimide film or epoxy resin, and is a film that easily is transformed into a liquid, so that it easily is applied to the side walls of the conductive bumps 19. As the material of the conductive bumps 19, nickel formed by electroless plating or a nickel alloy is used.

The distance between adjacent conductive bumps 19, as well as the distance between adjacent bump pads 12, 18 are set to 21.2 μm, the same distance as that between adjacent cold cathode areas. Because the side wall insulating film 20 is formed between the conductive bumps 19, short circuiting does not occur between adjacent conductive bumps 19, and adjacent conductive bumps 19 are not electrically connected at a voltage lower than the voltage at which a breakdown due to withstand voltage of the side wall insulating film 20 occurs.

According to this embodiment, the conductive bumps 19 and the side wall insulating film 20 together constitute the power supply structure 4, but it is also possible to use an anisotropic conductive polymer film containing conductive particles.

The electrode configuration, material, shape and voltage described above vary according to the size, application and required performance of electron emitting element, and it is also possible to use a desired configuration, material, shape and voltage.

According to the configuration of this embodiment, the image pickup element anode portion 8, the electron source assembly 2 and part of the substrate 1 are included in the vacuum container 3. Although the image pickup element anode portion 8, the electron source assembly 2 and part of the substrate 1 are exposed to the vacuum environment of the vacuum container 3, the outgas therefrom is composed mostly of nitrogen, oxygen and hydrogen, which can be removed sufficiently in the step of vacuum-sealing the vacuum container 3.

On the other hand, the polyimide film or polymer material such as epoxy resin that forms part of the power supply structure 4 may generate a large amount of outgas in a high vacuum environment. However, according to this embodiment, the power supply structure 4 is disposed outside the vacuum container 3. Thereby, it is possible to use a power supply structure in which the spacing between adjacent wires is reduced while preventing troubles in the emission of electron beam due to a degradation in the degree of vacuum or a contamination of the electron sources caused by gas released in the vacuum container 3. Therefore, a larger number of electron sources can be disposed at a high density in the array, providing an image pickup element having high resolution characteristics.

### Embodiment 2

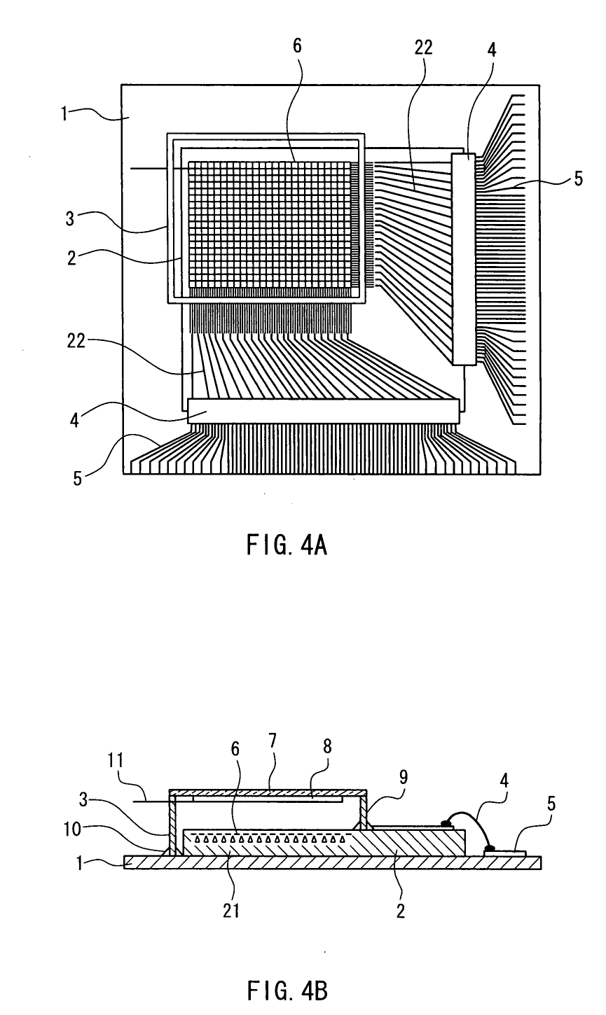

FIGS. 4A and 4B are schematic views of an electron emitting element according to Embodiment 2. Similarly to Embodiment 1, the configuration shown in FIGS. 4A and 4B shows an example in which the electron emitting element serves as an image pickup element. FIG. 4A shows a plan view, and FIG. 4B shows a cross sectional view.

An electron source assembly 2 and a vacuum container 3 are disposed on a substrate 1. In the vacuum container 3, part of the electron source assembly 2 is disposed. A power supply structure 4 is connected to an external terminal structure 5. With this connection, the electron source assembly 2 and the outside of the image pickup element can be connected electrically. The configuration described thus far is the same as in Embodiment 1.

According to this embodiment, a region for forming wiring patterns 22 is provided on a silicon substrate 21. In this region, the spacing between adjacent wires of the wiring patterns 22 is set to be greater at the power supply structure 4 side than at a cold cathode array 6 side. In order to dispose the wiring patterns 22, the outer dimension of the electron source assembly 2 is increased to 35 mm square, larger than that of Embodiment 1 which is about 15 mm square.

For the power supply structure 4, a wire bonding method using a gold wire or aluminum wire can be used. In this embodiment, a ball bonding method using a gold wire is used. The distance between adjacent wires of the wiring patterns extending from the cold cathode array 6 in the power supply structure 4 is set to 50 μm, and the diameter of the wires used in the wire bonding is set to φ 25 μm. When the wire bonding method is used as the power supply structure 4, structurally, the wire bonded portions are exposed to the outside, and thus the wire bonded portions are molded with a resin such as epoxy resin.

Similarly to Embodiment 1, in this embodiment, the power supply structure 4 is disposed outside the vacuum container 3. Accordingly, even when the wire bonded portions are molded with a resin as described above, it is possible to prevent problems in the emission of electron beam due to a degradation in the degree of vacuum or a contamination of the electron sources which are caused by gas released in the vacuum container 3.

Furthermore, according to this embodiment, in a part of the electron source assembly 2, a region is formed in which the distance between adjacent wires of the wiring patterns extending from the cold cathode array 6 is increased. Thereby, even when the electron sources are disposed at a high density in the array, the effective distance between adjacent wires in the power supply structure 4 can be increased, and thus a wire bonding method, which is versatile, can be employed. Therefore, similarly to Embodiment 1, a larger number of electron sources can be disposed at a high density in the array, and thus it is possible to provide an image pickup element having high resolution characteristics.

Although Embodiments 1 and 2 describe the case where the electron emitting elements serve as an image pickup element, similar effects can be obtained even when the electron emitting elements serve as an image displaying element.

As described above, according to the present invention, it is possible to realize a high density wiring structure without causing a degradation in the vacuum environment and a contamination of the electron sources, and therefore the present invention is useful as an electron emitting element used for image display, image pickup, or the like.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An electron emitting element comprising a vacuum container, electron sources that emit an electron beam, and a power supply structure that supplies a voltage to the electron sources,
wherein the electron sources are formed on a silicon substrate, and the power supply structure is disposed outside the vacuum container.

2. The electron emitting element according to claim 1,
wherein the vacuum container and at least part of the silicon substrate are seal-bonded with a sealant, and the sealant is low melting point fusing glass having a thermal expansion coefficient approximately equal to that of the silicon substrate.

3. The electron emitting element according to claim 1,
wherein the silicon substrate has thereon a region in which a wiring pattern that supplies a voltage to the electron source from the power supply structure is formed, and, in the region, a spacing between adjacent wires of the wiring pattern is greater at the power supply structure side than at the electron source side.
